(19) United States
(12) Patent Application Publication
(10) Pub. No.: US 2022/0077456 A1
(43) Pub. Date: Mar. 10, 2022

(54) CORE-SHELL NICKEL FERRITE AND PREPARATION METHOD THEREOF, NICKEL FERRITE@C MATERIAL AND PREPARATION METHOD AND APPLICATION THEREOF

(71) Applicant: QILU UNIVERSITY OF TECHNOLOGY, Shandong (CN)

(72) Inventors: Guowei ZHOU, Shandong (CN); Tianli LIU, Shandong (CN); Shaonan GU, Shandong (CN); Qinghua GONG, Shandong (CN); Bin SUN, Shandong (CN); Qian WANG, Shandong (CN); Xuefeng SUN, Shandong (CN)

(73) Assignee: QILU UNIVERSITY OF TECHNOLOGY, Shandong (CN)

(21) Appl. No.: 17/297,465

(22) PCT Filed: May 22, 2020
(86) PCT No.: PCT/CN2020/091872

§ 371 Date: May 27, 2021

(30) Foreign Application Priority Data
Nov. 8, 2019 (CN) 201911088948.6

(51) Int. Cl. H01M 4/36; C01G 53/00; C01B 32/05; H01M 4/58; H01M 4/62; H01M 4/134; H01M 4/1397; H01M 4/04; H01M 10/0525

(52) U.S. Cl. CPC H01M 4/366; C01G 53/00; C01B 32/05; H01M 4/5825; H01M 4/628; H01M 4/134; H01M 2004/027; H01M 4/0404; H01M 10/0525; C01P 2002/72; C01P 2004/04; C01P 2004/03; C01P 2006/40; H01M 4/1397

(57) ABSTRACT

The present disclosure provides core-shell nickel ferrite, a nickel ferrite@C material and preparation methods and application thereof. The preparation method of the core-shell nickel ferrite includes: preparing nickel iron glycerate ball powder by a solvothermal method; and under an air condition, heating the nickel iron glycerate ball powder at a heating rate of lower than 1.5° C./min to not less than 350° C. for performing calcination to obtain the core-shell nickel ferrite. The preparation method of the nickel ferrite@C material includes: performing a phenolic resin condensation reaction on the core-shell nickel ferrite, resorcinol and formaldehyde to obtain a phenolic resin (RF) coated core-shell nickel ferrite@RF composite material; and in an inert atmosphere, calcining and carbonizing the nickel ferrite@RF composite material to obtain the nickel ferrite@C material.

### BACKGROUND

### Technical Field

The present disclosure belongs to the technical field of lithium ion batteries, relates to negative electrode materials of lithium ion batteries, and in particular relates to core-shell nickel ferrite and a preparation method thereof, a nickel ferrite@C material and a preparation method and application thereof.

Information of the Related Art part is merely disclosed to increase the understanding of the overall background of the present disclosure, but is not necessarily regarded as acknowledging or suggesting, in any form, that the information constitutes the prior art known to a person of ordinary skill in the art.

Energy is the foundation of human survival and economic development. However, with continuous and rapid development of the world economy, problems such as energy shortage and environmental pollution have gradually deepened, and the contradiction between energy supply and demand has become increasingly prominent. New energy technology is a recognized high and new technology. As an important part of the new energy field, the battery industry has become a new hot spot for global development. Currently, lithium ion batteries have been widely used as an important energy source, and have broad application prospects in the fields such as electronic communication and transportation. Lithium ion batteries have high working voltage, large specific energy, long cycle life, good safety performance, no memory effect, small size, and light weight; and lithium ion batteries do not contain cadmium, lead, mercury and other elements that pollute the environment. Therefore, lithium ion batteries are an ideal power source for portable electronic devices such as mobile phones and notebook computers, and are expected to become one of the main power sources for electric vehicles and power grids.

Transition metal oxides with a spinel structure have higher theoretical specific capacity. The theoretical specific capacity of nickel ferrite (NiFe₂O₄) is 915 mA h g⁻¹, which is about three times the theoretical specific capacity (375 mA h g⁻¹) of the current commercial graphite negative electrodes, and nickel ferrite has good electrochemical performance. In addition, iron and nickel have extensive sources, large earth reserves, simple preparation methods and environmental friendliness, which make iron and nickel become ideal materials for the next generation of the negative electrodes of lithium ion batteries. Although the theoretical specific capacity of NiFe₂O₄ is very high, the volume expansion effect is large during the charge and discharge process, leading to serious capacity attenuation, large irreversible capacity, and poor cycle performance. In order to improve the situation, the Chinese patent document with publication number CN 107673752 A (application number 201710861283.2) disclosed an NiFe₂O₄ conductive material doped with nano-TiN and other additives and a preparation method thereof, including: mixing NiO powder, Fe₂O₃ powder, nano TiN powder and other additives; adding a dispersant to the mixture and mixing uniformly; and calcining the mixture under inert gas to obtain the NiFe₂O₄ conductive material doped with nano TiN and other additives. However, the inventors of the present disclosure discovered that the material has uneven morphology and poor dispersibility. The Chinese patent document with publication number CN 103700842 A (application number 201310646625.0) disclosed an NiFe₂O₄/C negative electrode material of lithium ion batteries and a preparation method thereof, including: using nickel salt and iron salt as main raw materials and hydrazine as a reducing agent, performing an oxidation-reduction reaction to obtain the precursor NiFe₂O₄, coating the precursor with a sugar material, and then performing calcining in an argon atmosphere to obtain an NiFe₂O₄/C composite material. However, the inventors of the present disclosure discovered that the agglomeration of the material is relatively serious and the cycle performance is poor.

### SUMMARY

### Technical Problem

In order to solve the shortcomings of the prior art, the objective of the present disclosure is to provide core-shell nickel ferrite and a nickel ferrite@C material, as well as preparation methods and application thereof. The core-shell nickel ferrite can be used to prepare a nickel ferrite@C core-shell material with a carbon source. The nickel ferrite@C core-shell material has the advantages of uniform morphology, good dispersibility, high specific capacity, stable cycle performance, and the like when being used as a negative electrode of lithium ion batteries.

To achieve the objective, the present disclosure includes the following technical solutions:

On the one hand, core-shell nickel ferrite is provided, which has a core diameter of 425-450 nm, a shell thickness of 25-30 nm, and a core-shell spacing of 25-30 nm.

On the other hand, a preparation method of the core-shell nickel ferrite is provided, which includes: using nickel salt, iron salt and glycerin as raw materials, preparing nickel iron glycerate ball powder by a solvothermal method; and under an air condition, heating the nickel iron glycerate ball powder at a heating rate of lower than 1.5° C./min to not less than 350° C. for performing calcination to obtain the core-shell nickel ferrite.

The present disclosure has found through experiments that the heating rate during calcination affects the structure of the nickel ferrite. When the heating rate is higher than 1.5° C./min (especially not lower than 2° C./min), solid spherical nickel ferrite is obtained. When the heating rate is lower than 1.5° C./min (especially not higher than 1° C./min), core-shell nickel ferrite with a core-shell spacing is obtained.

The NiFe₂O₄ core and NiFe₂O₄ shell prepared by the present disclosure have an obvious hollow space, and can shorten a transmission path of ions and electrons and improve the electrochemical performance.

In a third aspect, a nickel ferrite@C material is provided, which includes the above core-shell nickel ferrite, and the core-shell nickel ferrite is coated with a carbon coating.

The present disclosure uses the core-shell NiFe₂O₄ as a support carrier and a carbon layer as a protective layer, and can alleviate the problem of capacity attenuation caused by volume changes during charging and discharging of a lithium ion battery.

In a fourth aspect, a preparation method of a nickel ferrite@C material is provided, which includes: performing a phenolic resin condensation reaction on the above core-shell nickel ferrite, resorcinol and formaldehyde to obtain a phenolic resin (RF) coated core-shell nickel ferrite@RF composite material; and in an inert atmosphere, calcining and carbonizing the nickel ferrite@RF composite material to obtain the nickel ferrite@C material.

In the present disclosure, the core-shell NiFe₂O₄ is coated with a mesoporous carbon layer formed by high-temperature carbonization of phenolic resin, and the mesoporous carbon layer can effectively prevent electrochemical wear due to elastic properties thereof.

In a fifth aspect, application of the above nickel ferrite@C material in lithium ion batteries is provided.

In a sixth aspect, a negative electrode of lithium ion batteries is provided, and an active material of the negative electrode of lithium ion batteries is the above nickel ferrite@C material.

In a seventh aspect, a lithium ion battery is provided, and a negative electrode of the lithium ion battery adopts the above negative electrode of lithium ion batteries.

Beneficial effects of the present disclosure are as follows.

(1) The core-shell NiFe₂O₄ prepared by the present disclosure can alleviate capacity attenuation caused by dramatic volume change of lithium-ion batteries during charging and discharging. The core of the NiFe₂O₄ can be used as a strong core to support huge volume shrinkage of a shell layer and ensure structural integrity of an electrode during long-term cycling. A hollow space between the core and the shell can provide part of the space to accommodate the volume change of the shell layer and shorten the electron transmission path.

(2) The present disclosure adopts coating with the carbon layer. The carbon layer formed after RF carbonization has a small volume change during charging and discharging, has good cycle stability, and can enhance the conductivity of the material.

(3) The core-shell NiFe₂O₄@C composite material prepared by the present disclosure has good dispersibility and no obvious adhesion phenomenon. The product performance is good, the synthesis process is simple, and the method has low equipment requirements and low costs.

### BRIEF DESCRIPTION OF THE DRAWINGS

The accompanying drawings constituting a part of the present disclosure are used to provide further understanding of the present disclosure. Exemplary embodiments of the present disclosure and descriptions thereof are used to explain the present disclosure, and do not constitute an improper limitation to the present disclosure.

FIG. 1 is an X-ray diffraction pattern (XRD) of core-shell NiFe₂O₄ prepared in Embodiment 1 of the present disclosure.

FIG. 2 is comparison diagrams in transmission electron micrographs of products prepared in Embodiment 1 and Embodiment 2 of the present disclosure; (a) is a transmission electron micrograph (TEM) of core-shell NiFe₂O₄ prepared in Embodiment 1 of the present disclosure; and (b) is a transmission electron micrograph (TEM) of NiFe₂O₄ solid spheres prepared in Embodiment 2 of the present disclosure.

FIG. 3 is comparison diagrams in scanning electron micrographs of products prepared in Embodiment 1 and Embodiment 2 of the present disclosure; (a) is a scanning electron micrograph (SEM) of core-shell NiFe₂O₄ prepared in Embodiment 1 of the present disclosure; and (b) is a scanning electron micrograph (SEM) of a core-shell NiFe₂O₄@C composite material prepared in Embodiment 1 of the present disclosure.

FIG. 4 is a transmission electron micrograph (TEM) of a core-shell NiFe₂O₄@C composite material prepared in Embodiment 1 of the present disclosure.

FIG. 5 is a comparison diagram of cycle performance of a core-shell NiFe₂O₄@C composite material prepared in Embodiment 1 and solid spherical NiFe₂O₄@C composite material prepared in Embodiment 2 of the present disclosure.

### DESCRIPTION OF THE EMBODIMENTS

It should be noted that, the following detailed descriptions are all exemplary, and are intended to provide further descriptions of the present disclosure. Unless otherwise specified, all technical and scientific terms used herein have the same meaning as commonly understood by a person of ordinary skill in the technical field to which the present disclosure belongs.

It should be noted that terms used herein are only for describing specific implementations and are not intended to limit exemplary implementations according to the present disclosure. As used herein, the singular form is also intended to include the plural form unless the context clearly dictates otherwise. In addition, it should further be understood that, terms “include” and/or “include” used in this specification indicate that there are features, steps, operations, devices, components, and/or combinations thereof.

In view of serious capacity attenuation, large irreversible capacity, and poor cycle performance caused by the large volume expansion effect of the existing NiFe₂O₄, the present disclosure provides core-shell nickel ferrite and a preparation method thereof, a nickel ferrite@C material and a preparation method and application thereof.

A typical implementation of the present disclosure provides core-shell nickel ferrite, a core diameter is 425-450 nm, a shell thickness is 25-30 nm, and a core-shell spacing is 25-30 nm.

In one or more embodiments of the implementation, the core diameter is 435-445 nm, the shell thickness is 25-27 nm, and the core-shell spacing is 25-27 nm.

Another implementation of the present disclosure provides a preparation method of the core-shell nickel ferrite, which includes: using nickel salt, iron salt and glycerin as raw materials, preparing nickel iron glycerate ball powder by a solvothermal method; and under an air condition, heating the nickel iron glycerate ball powder at a heating rate of lower than 1.5° C./min to not less than 350° C. for performing calcination to obtain the core-shell nickel ferrite.

The present disclosure has found through experiments that the heating rate during calcination affects the structure of the nickel ferrite. When the heating rate is higher than 1.5° C./min (especially not lower than 2° C./min), solid spherical nickel ferrite is obtained. When the heating rate is lower than 1.5° C./min (especially not higher than 1° C./min), core-shell nickel ferrite with a core-shell spacing is obtained.

The NiFe₂O₄ core and NiFe₂O₄ shell prepared by the present disclosure have an obvious hollow space, and can shorten a transmission path of ions and electrons and improve the electrochemical performance.

The nickel salt as described in the present disclosure refers to a compound with nickel ions as positive ions, such as nickel chloride, nickel nitrate and nickel sulfate.

The iron salt as described in the present disclosure refers to a compound with ferric ions as positive ions, such as ferric chloride, ferric nitrate and ferric sulfate.

The solvothermal method as described in the present disclosure refers to a synthetic method using an organic substance or a non-aqueous solvent as a solvent, and an original mixture is reacted at a certain temperature and self-generated pressure of the solution (closed condition).

In one or more embodiments of the implementation, in the nickel salt and the iron salt, a molar ratio of nickel ions to iron ions is 1:(1.9-2.1).

In one or more embodiments of the implementation, the solvent of a solvothermal reaction system is isopropanol.

In one or more embodiments of the implementation, a reaction temperature of the solvothermal method is 150-200° C., and a reaction time is 4-8 h. When the solvothermal temperature is 180±2° C. and the reaction time is 5.5-6.5 h, the reaction effect is better.

In one or more embodiments of the implementation, a calcination temperature is 350-450° C., the heating rate is 0.9-1.1° C., and a calcination time is 1.5-2.5 h.

A third implementation of the present disclosure provides a nickel ferrite@C material, which includes the above core-shell nickel ferrite, and the core-shell nickel ferrite is coated with a carbon coating.

The present disclosure uses the core-shell NiFe₂O₄ as a support carrier and a carbon layer as a protective layer, and can alleviate the problem of capacity attenuation caused by volume changes during charging and discharging of a lithium ion battery.

In one or more embodiments of the implementation, a thickness of the carbon coating is 20-25 nm.

A fourth implementation of the present disclosure provides a preparation method of a nickel ferrite@C material, which includes: performing a phenolic resin condensation reaction on the above core-shell nickel ferrite, resorcinol and formaldehyde to obtain a phenolic resin (RF) coated core-shell nickel ferrite@RF composite material; and in an inert atmosphere, calcining and carbonizing the nickel ferrite@RF composite material to obtain the nickel ferrite@C material.

In the present disclosure, the core-shell NiFe₂O₄ is coated with a mesoporous carbon layer formed by high-temperature carbonization of phenolic resin, and the mesoporous carbon layer can effectively prevent electrochemical wear due to elastic properties thereof.

The inert atmosphere as described in the present disclosure refers to a gas atmosphere that does not contain oxygen and can avoid oxidation reactions, such as nitrogen and argon.

In one or more embodiments of the implementation, a rate of charge of the core-shell nickel ferrite to the resorcinol to the formaldehyde is 50 mg:(0.9-1.1) g:(0.11-0.13) mL.

In one or more embodiments of the implementation, the phenolic resin condensation reaction is performed under an alkaline condition.

In the series of embodiments, ammonia water is added to a phenolic resin condensation reaction system. A rate of charge of the core-shell nickel ferrite to the ammonia water is 50 mg:(0.9-1.1) mL.

In one or more embodiments of the implementation, a solvent of the phenolic resin condensation reaction system is an aqueous solution of ethanol. When a volume ratio of the ethanol to water is 2:(0.9-1.1), the reaction effect is better.

In one or more embodiments of the implementation, a temperature of calcination and carbonization is 550-650° C., and a calcination time is 1.5-2.5 h.

A fifth implementation of the present disclosure provides application of the above nickel ferrite@C material in lithium ion batteries.

A sixth implementation of the present disclosure provides a negative electrode of lithium ion batteries, and an active material of the negative electrode of lithium ion batteries is the above nickel ferrite@C material.

In one or more embodiments of the implementation, a binder and a conductive agent are included.

In one or more embodiments of the implementation, a preparation method of the negative electrode includes: mixing the active material, the binder and the conductive agent uniformly, adding a solvent to prepare a slurry, coating a surface of a current collector with the slurry, and then drying the slurry.

A seventh implementation of the present disclosure provides a lithium ion battery, and a negative electrode of the lithium ion battery adopts the above negative electrode of lithium ion batteries.

In one or more embodiments of the implementation, the lithium ion battery is a CR2032 button cell.

In order to enable those skilled in the art to understand the technical solutions of the present disclosure more clearly, the technical solutions of the present disclosure will be described in detail below with reference to specific embodiments.

### Embodiment 1

(1) First, 8 mL of glycerin was added to 40 mL of isopropanol and the mixture was stirred uniformly. Then 0.0363 g of Ni(NO₃)₂.6H₂O and 0.101 g of Fe(NO₃)₃.9H₂O were added in sequence, and the mixture was stirred uniformly at room temperature.

(2) The homogeneous liquid obtained in step (1) was transferred to a 100 mL polytetrafluoroethylene lined autoclave, and underwent a solvothermal reaction at 180° C. for 6 h. After natural cooling to room temperature, centrifugation, washing and drying were performed to obtain yellow nickel iron glycerate ball powder. In the air, the temperature was raised to 400° C. at 1° C./min, and the nickel iron glycerate ball powder was calcined for 2 h. Then the product was cooled to room temperature naturally to obtain core-shell NiFe₂O₄.

(3) The core-shell NiFe₂O₄ obtained in step (2) was dispersed ultrasonically in a mixed solution of 10 mL of water and 20 mL of ethanol. 1 mL of NH₃.H₂O (28 wt %), 1 g of resorcinol and 0.12 mL of formaldehyde were added, and the mixture was stirred for 2 h. Centrifugation, washing and drying were performed to obtain a core-shell NiFe₂O₄@RF composite material. In an argon atmosphere, the temperature was raised to 600° C. and the core-shell NiFe₂O₄@RF composite material was calcined for 2 h to obtain a core-shell NiFe₂O₄@C composite material.

### Embodiment 2

(1) First, 8 mL of glycerin was added to 40 mL of isopropanol and the mixture was stirred uniformly. Then 0.0363 g of Ni(NO₃)₂.6H₂O and 0.101 g of Fe(NO₃)₃.9H₂O were added in sequence, and the mixture was stirred uniformly at room temperature.

(2) The homogeneous liquid obtained in step (1) was transferred to a 100 mL polytetrafluoroethylene lined autoclave, and underwent a solvothermal reaction at 180° C. for 6 h. After natural cooling to room temperature, centrifugation, washing and drying were performed to obtain yellow nickel iron glycerate ball powder. In the air, the temperature was raised to 400° C. at 2° C./min, and the nickel iron glycerate ball powder was calcined for 2 h. Then the product was cooled to room temperature naturally to obtain solid spherical NiFe₂O₄.

(3) The solid spherical NiFe₂O₄ obtained in step (2) was dispersed ultrasonically in a mixed solution of 10 mL of water and 20 mL of ethanol. 1 mL of NH₃.H₂O (28 wt %), 1 g of resorcinol and 0.12 mL of formaldehyde were added, and the mixture was stirred for 2 h. Centrifugation, washing and drying were performed to obtain a core-shell NiFe₂O₄@RF composite material. In an argon atmosphere, the temperature was raised to 600° C. and the solid spherical NiFe₂O₄@RF composite material was calcined for 2 h to obtain a solid spherical NiFe₂O₄@C composite material.

### Embodiment 3

(1) First, 8 mL of glycerin was added to 40 mL of isopropanol and the mixture was stirred uniformly. Then 0.0363 g of Ni(NO₃)₂.6H₂O and 0.101 g of Fe(NO₃)₃.9H₂O were added in sequence, and the mixture was stirred uniformly at room temperature.

(2) The homogeneous liquid obtained in step (1) was transferred to a 100 mL polytetrafluoroethylene lined autoclave, and underwent a solvothermal reaction at 160° C. for 8 h. After natural cooling to room temperature, centrifugation, washing and drying were performed to obtain yellow nickel iron glycerate ball powder. In the air, the temperature was raised to 400° C. at 1° C./min, and the nickel iron glycerate ball powder was calcined for 2 h. Then the product was cooled to room temperature naturally to obtain core-shell NiFe₂O₄.

(3) The solid spherical NiFe₂O₄ obtained in step (2) was dispersed ultrasonically in a mixed solution of 10 mL of water and 20 mL of ethanol. 1 mL of NH₃.H₂O (28 wt %), 1 g of resorcinol and 0.12 mL of formaldehyde were added, and the mixture was stirred for 2 h. Centrifugation, washing and drying were performed to obtain a core-shell NiFe₂O₄@RF composite material. In an argon atmosphere and in an inert atmosphere, the temperature was raised to 600° C. and the core-shell NiFe₂O₄@RF composite material was calcined for 2 h to obtain a core-shell NiFe₂O₄@C composite material.

### Embodiment 4

(1) First, 8 mL of glycerin was added to 40 mL of isopropanol and the mixture was stirred uniformly. Then 0.0363 g of Ni(NO₃)₂.6H₂O and 0.101 g of Fe(NO₃)₃.9H₂O were added in sequence, and the mixture was stirred uniformly at room temperature.

(2) The homogeneous liquid obtained in step (1) was transferred to a 100 mL polytetrafluoroethylene lined autoclave, and underwent a solvothermal reaction at 180° C. for 6 h. After natural cooling to room temperature, centrifugation, washing and drying were performed to obtain yellow nickel iron glycerate ball powder. In the air, the temperature was raised to 400° C. at 1° C./min, and the nickel iron glycerate ball powder was calcined for 2 h. Then the product was cooled to room temperature naturally to obtain core-shell NiFe₂O₄.

(3) The core-shell NiFe₂O₄ obtained in step (2) was dispersed ultrasonically in a mixed solution of 10 mL of water and 20 mL of ethanol. 1 mL of NH₃.H₂O (28 wt %), 2 g of resorcinol and 0.24 mL of formaldehyde were added, and the mixture was stirred for 2 h. Centrifugation, washing and drying were performed to obtain a core-shell NiFe₂O₄@RF composite material. In an argon atmosphere, the temperature was raised to 600° C. and the core-shell NiFe₂O₄@RF composite material was calcined for 2 h to obtain a core-shell NiFe₂O₄@C composite material.

### Embodiment 5

(1) First, 8 mL of glycerin was added to 40 mL of isopropanol and the mixture was stirred uniformly. Then 0.0363 g of Ni(NO₃)₂.6H₂O and 0.101 g of Fe(NO₃)₃.9H₂O were added in sequence, and the mixture was stirred uniformly at room temperature.

(2) The homogeneous liquid obtained in step (1) was transferred to a 100 mL polytetrafluoroethylene lined autoclave, and underwent a solvothermal reaction at 180° C. for 6 h. After natural cooling to room temperature, centrifugation, washing and drying were performed to obtain yellow nickel iron glycerate ball powder. In the air, the temperature was raised to 400° C. at 1° C./min, and the nickel iron glycerate ball powder was calcined for 2 h. Then the product was cooled to room temperature naturally to obtain core-shell NiFe₂O₄.

(3) The core-shell NiFe₂O₄ obtained in step (2) was dispersed ultrasonically in a mixed solution of 10 mL of water and 20 mL of ethanol. 1 mL of NH₃.H₂O (28 wt %), 0.5 g of resorcinol and 0.06 mL of formaldehyde were added, and the mixture was stirred for 2 h. Centrifugation, washing and drying were performed to obtain a core-shell NiFe₂O₄@RF composite material. In an argon atmosphere, the temperature was raised to 600° C. and the core-shell NiFe₂O₄@RF composite material was calcined for 2 h to obtain a core-shell NiFe₂O₄@C composite material.

The electrochemical performance of the core-shell NiFe₂O₄@C composite material as a negative electrode material of lithium-ion batteries was evaluated by a CR2032 button cell. The battery assembly process is as follows: the active material, the binder and the conductive agent were mixed uniformly in a mass ratio of 7:2:1, and a certain amount of N-methylpyrrolidone was added to prepare a uniform slurry. Then, a copper foil was uniformly coated with the slurry and baked at 60° C. under a vacuum condition for 24 h. The battery assembly sequence is: a positive case, a negative pole piece, an electrolyte, a diaphragm, an electrolyte, a lithium sheet, a gasket, a spring sheet and a negative case. The diaphragm is a Celgard 2300 membrane, the electrolyte is 1 mol/L LiPF6 dissolved in a mixture of ethylene carbonate, dimethyl carbonate and ethyl methyl carbonate, and the whole assembly process was performed in a glove box filled with argon. The assembled battery was tested using a Neware battery test system.

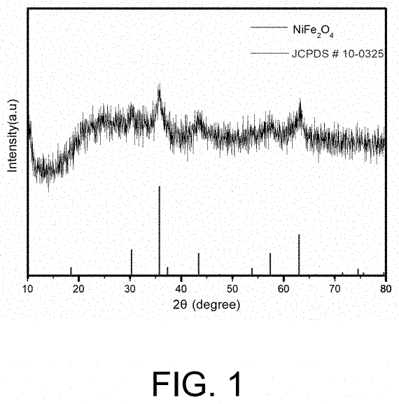

FIG. 1 is an X-ray diffraction pattern (XRD) of the core-shell NiFe₂O₄ prepared in Embodiment 1. There are obvious characteristic diffraction peaks at 30°, 36°, 43°, 57.5° and 63°, and the characteristic diffraction peaks are consistent with NiFe₂O₄ (JCPDS No. 10-0325), and represent NiFe₂O₄ (220), (311), (400), (511) and (440) crystal planes, respectively.

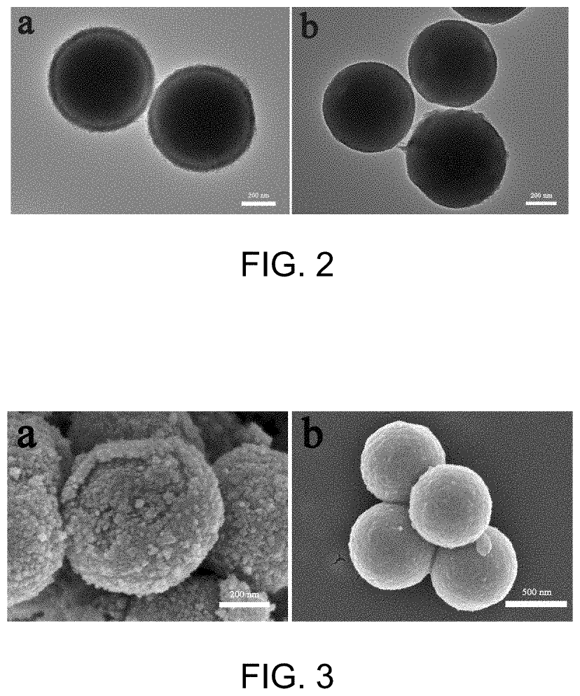

In FIG. 2, (a) is a transmission electron micrograph of the core-shell NiFe₂O₄ prepared in Embodiment 1, and (b) is a transmission electron micrograph of the solid spherical NiFe₂O₄ prepared in Embodiment 2 of the present disclosure. As shown in the Figure, (a) has an obvious core-shell structure, and a certain spacing exists between the core and the shell, (b) shows a solid ball.

In FIG. 3, (a) is a scanning electron micrograph of the core-shell NiFe₂O₄ prepared in Embodiment 1. The NiFe₂O₄ spheres are composed of fine particles. The core-shell structure can be clearly seen from the damage. The Figure (b) is a scanning electron micrograph of the core-shell NiFe₂O₄@RF prepared in Embodiment 1 of the present disclosure. As shown in the Figure, the sample has a uniform morphology, no adhesion and good dispersibility.

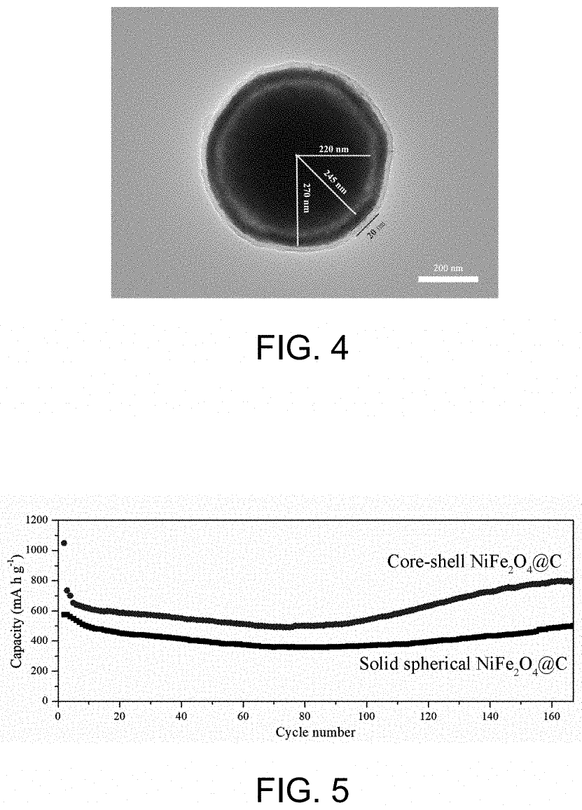

FIG. 4 is a transmission electron micrograph of the core-shell NiFe₂O₄@C prepared in Embodiment 1. From the Figure, the radius of the core-shell NiFe₂O₄ is 270 nm, the shell thickness is 25 nm, the core-shell spacing is 25 nm, and the carbon coating is 20 nm.

FIG. 5 is a comparison diagram of cycle performance of the core-shell NiFe₂O₄@C composite material prepared in Embodiment 1 and the solid spherical NiFe₂O₄@C composite material prepared in Embodiment 2 as negative electrodes of lithium ion batteries. At a current density of 0.5 A g⁻¹, the core-shell NiFe₂O₄@C composite material prepared in Embodiment 1 has first discharge and charge capacities of 1048 mA h g⁻¹ and 733 mA h g⁻¹, respectively, and the first coulombic efficiency is 70%. The second discharge capacity is 735 mA h g⁻¹, and the irreversible capacity loss may be attributed to the irreversible reaction of the electrolyte and the formation of a solid electrolyte interfacial film (SEI). In the cycle process, the battery capacity shows a trend of decreasing first and then increasing. After 165 cycles, the discharge capacity reached 792.9 mA h g⁻¹. Compared with the solid spherical NiFe₂O₄@C composite material prepared in Embodiment 2, the cycle performance is greatly improved.

The foregoing descriptions are merely exemplary embodiments of the present disclosure, but are not intended to limit the present disclosure. The present disclosure may include various modifications and changes for a person skilled in the art. Any modification, equivalent replacement, or improvement made within the spirit and principle of the present disclosure shall fall within the protection scope of the present disclosure.

1. A core-shell nickel ferrite, wherein a core diameter is 425-450 nm, a shell thickness is 25-30 nm, and a core-shell spacing is 25-30 nm.

2. The core-shell nickel ferrite of claim 1, wherein the core diameter is 435-445 nm, the shell thickness is 25-27 nm, and the core-shell spacing is 25-27 nm.

3. A preparation method of core-shell nickel ferrite, comprising: using a nickel salt, an iron salt and a glycerin as raw materials, preparing a nickel iron glycerate ball powder by a solvothermal method; and under an air condition, heating the nickel iron glycerate ball powder at a heating rate of lower than 1.5° C./min to not less than 350° C. for performing calcination to obtain the core-shell nickel ferrite.

4. The preparation method of the core-shell nickel ferrite of claim 3, wherein in the nickel salt and the iron salt, a molar ratio of nickel ions to iron ions is 1:(1.9-2.1);
or, a solvent of a solvothermal reaction system is isopropanol;
or, a reaction temperature of the solvothermal method is 150-200° C., and a reaction time is 4-8 h;
or, a calcination temperature is 350-450° C., a heating rate is 0.9-1.1° C., and a calcination time is 1.5-2.5 h.

5. A nickel ferrite@C material, comprising the core-shell nickel ferrite of claim 1, and the core-shell nickel ferrite is coated with a carbon coating; and
a thickness of the carbon coating is 20-25 nm.

6. A preparation method of a nickel ferrite@C material, comprising: performing a phenolic resin condensation reaction on the core-shell nickel ferrite of claim 1, resorcinol and formaldehyde to obtain a phenolic resin (RF) coated core-shell nickel ferrite@RF composite material; and in an inert atmosphere, calcining and carbonizing the nickel ferrite@RF composite material to obtain the nickel ferrite@C material.

7. The preparation method of the nickel ferrite@C material of claim 6, wherein a rate of charge of the core-shell nickel ferrite to the resorcinol to the formaldehyde is 50 mg: (0.9-1.1) mg: (0.11-0.13) mL;
or, the phenolic resin condensation reaction is performed under an alkaline condition, and ammonia water is added to a phenolic resin condensation reaction system;
or, a solvent of the phenolic resin condensation reaction system is an aqueous solution of ethanol, and a volume ratio of the ethanol to water is 2:(0.9-1.1);
or, a temperature of the calcination and carbonization is 550-650° C., and a calcination time is 1.5-2.5 h.

8. Application of the nickel ferrite@C material of claim 5 in lithium ion batteries.

9. A negative electrode of lithium ion batteries, wherein an active material of the negative electrode is the nickel ferrite@C material of claim 5;
a binder and a conductive agent are comprised; and
a preparation method of the negative electrode comprises: mixing the active material, the binder and the conductive agent uniformly, adding a solvent to prepare a slurry, coating a surface of a current collector with the slurry, and then drying the slurry.

10. A lithium ion battery, wherein a negative electrode of the lithium ion battery adopts the negative electrode of lithium ion batteries of claim 9.

11. A nickel ferrite@C material, comprising the core-shell nickel ferrite of claim 2, and the core-shell nickel ferrite is coated with a carbon coating; and
a thickness of the carbon coating is 20-25 nm.

12. A nickel ferrite@C material, comprising the core-shell nickel ferrite prepared by the preparation method of claim 3, and the core-shell nickel ferrite is coated with a carbon coating; and
a thickness of the carbon coating is 20-25 nm.

13. A nickel ferrite@C material, comprising the core-shell nickel ferrite prepared by the preparation method of claim 4, and the core-shell nickel ferrite is coated with a carbon coating; and
a thickness of the carbon coating is 20-25 nm.

14. A preparation method of a nickel ferrite@C material, comprising: performing a phenolic resin condensation reaction on the core-shell nickel ferrite of claim 2, resorcinol and formaldehyde to obtain a phenolic resin (RF) coated core-shell nickel ferrite@RF composite material; and in an inert atmosphere, calcining and carbonizing the nickel ferrite@RF composite material to obtain the nickel ferrite@C material.

15. A preparation method of a nickel ferrite@C material, comprising: performing a phenolic resin condensation reaction on the core-shell nickel ferrite prepared by the preparation method of claim 3, resorcinol and formaldehyde to obtain a phenolic resin (RF) coated core-shell nickel ferrite@RF composite material; and in an inert atmosphere, calcining and carbonizing the nickel ferrite@RF composite material to obtain the nickel ferrite@C material.

16. A preparation method of a nickel ferrite@C material, comprising: performing a phenolic resin condensation reaction on the core-shell nickel ferrite prepared by the preparation method of claim 4, resorcinol and formaldehyde to obtain a phenolic resin (RF) coated core-shell nickel ferrite@RF composite material; and in an inert atmosphere, calcining and carbonizing the nickel ferrite@RF composite material to obtain the nickel ferrite@C material.

17. A negative electrode of lithium ion batteries, wherein an active material of the negative electrode is the nickel ferrite@C material prepared by the preparation method of claim 6;
a binder and a conductive agent are comprised; and
a preparation method of the negative electrode comprises: mixing the active material, the binder and the conductive agent uniformly, adding a solvent to prepare a slurry, coating a surface of a current collector with the slurry, and then drying the slurry.

18. A negative electrode of lithium ion batteries, wherein an active material of the negative electrode is the nickel ferrite@C material prepared by the preparation method of claim 7;
a binder and a conductive agent are comprised; and
a preparation method of the negative electrode comprises: mixing the active material, the binder and the conductive agent uniformly, adding a solvent to prepare a slurry, coating a surface of a current collector with the slurry, and then drying the slurry.
